(19) United States
(12) Patent Application Publication
(10) Pub. No.: US 2019/0009164 A1
(43) Pub. Date: Jan. 10, 2019

(54) WHEEL ASSEMBLY AND A SKATEBOARD WITH A WHEEL ASSEMBLY

(71) Applicant: Stefan RUSSELL-UREN, Crestwood (AU)

(72) Inventor: Stefan RUSSELL-UREN, Crestwood (AU)

(21) Appl. No.: 16/031,163

(22) Filed: Jul. 10, 2018

(30) Foreign Application Priority Data
Jul. 10, 2017 (AU) 2017902692

(51) Int. Cl. A63C 17/22; B60B 33/00; B60B 33/02

(52) U.S. Cl. CPC A63C 17/226; B60B 33/0039; B60B 33/0049; B60B 2900/114; B60B 33/02; B60B 2900/351; B60B 33/0068

(57) ABSTRACT

A wheel assembly including a bearing at least partially rotatable about a bearing axis; a frame configured for mounting to the bearing to rotate about the bearing axis; an axle mounted to the frame; at least one wheel mounted on the axle to rotate about a wheel axis; and the frame includes a supporting lip on which the bearing is supportable in use. In one aspect, the invention includes a wheel assembly. The wheel assembly incudes a bearing at least partially rotatable about a bearing axis. The wheel assembly includes a frame configured for mounting to the bearing to rotate about the bearing axis. The wheel assembly further includes an axle mounted to the frame. Further, the wheel assembly includes at least one wheel mounted on the axle to rotate about a wheel axis. The frame includes a supporting lip on which the bearing is supportable in use.

### FIELD

The present invention relates to a wheel assembly and in particular to a wheel assembly that may be used on a skateboard. However, the invention is not limited to such an application.

The invention has been developed primarily for use with recreational devices such as skateboards and roller skates among other things, and will be described hereinafter with reference to its application to a skateboard. However, it will be appreciated that the invention is not limited to this particular field of use.

### BACKGROUND

Wheel assembly designs used in skateboards and other associated devices have scarcely changed in any meaningful way since their inception in the 1950s and 1960s.

However, this is not to say that there has not been a need for new wheel assembly designs that provide for a lower centre of gravity, greater manoeuvrability and provide for greater compactness in design. Current skateboard wheel assemblies offer strictly limited wheel movement about the horizontal axis effecting the ability for the skateboard to change direction rapidly. Also, current wheel designs tend to cause the deck of the skateboard to have a relatively high ride height, which increases the board's centre of gravity, having an adverse effect on the boards handling properties.

The above problems associated with current wheel assembly designs, result in a less enjoyable experience for the operator of the skateboard and as such a need exists for an improved wheel assembly.

It is to be understood that, if any prior art information is referred to herein, such reference does not constitute an admission that the information forms part of the common general knowledge in the art, in Australia or any other country.

### SUMMARY

It is an object of the present invention to overcome or at least ameliorate the disadvantages related to current wheel assemblies or at least to provide a useful alternative to current wheel assemblies.

In one aspect, the invention may be said to consist in a wheel assembly comprising:
a. a bearing at least partially rotatable about a bearing axis;
b. a frame configured for mounting to the bearing to rotate about the bearing axis;
c. an axle mounted to the frame;
d. at least one wheel mounted on the axle to rotate about a wheel axis; and
wherein the frame includes a supporting lip on which the bearing is supportable in use.

In one aspect, the invention may be said to consist in a wheel assembly. The wheel assembly incudes a bearing at least partially rotatable about a bearing axis. The wheel assembly includes a frame configured for mounting to the bearing to rotate about the bearing axis. The wheel assembly further includes an axle mounted to the frame. Further, the wheel assembly includes at least one wheel mounted on the axle to rotate about a wheel axis. The frame includes a supporting lip on which the bearing is supportable in use.

In a further aspect, the wheel assembly comprises a circlip to securely fix the frame to the bearing.

Preferably, the wheel assembly comprises an axle further comprising a first end and a second end, wherein the first end and the second end of the axle are attached to the frame.

In a further aspect, the frame comprises a first mounting hole to hold the first end of the axle and a second mounting hole to hold the second end of the axle.

Preferably, the wheel assembly includes a housing.

In a further aspect, the wheel assembly includes a locking plate that securely attaches to the housing and to the outer race of the bearing, such that the housing at least partially covers the wheel.

Preferably, the bearing is at least partially mounted to a housing adapted to at least partially cover the wheel.

In a further aspect, the invention may be said to consist of a skateboard, comprising:
a. a board comprising a first portion and a second portion; and
b. a plurality of wheel assemblies attached to the board, a first portion of the plurality of wheel assemblies being attached to the first portion of the board, and a second portion of the plurality of wheel assemblies being attached to the second portion of the board, wherein each of the plurality of wheel assemblies comprises:
   i. a bearing defining a bearing axis;
   ii. a frame configured for mounting to the bearing to rotate about the bearing axis;
   iii. an axle mounted to the frame;
   iv. at least one wheel mounted on the axle to rotate about a wheel axis;
   v. wherein the frame is reconfigurable between a locked condition and an unlocked condition, wherein when in the locked condition the frame is fixed in relation to its rotation about the bearing axis and in the unlocked condition the frame is free to rotate about the bearing axis.

In one aspect, the invention may be said to consist in a wheel assembly consisting of a board comprising a first portion and a second portion. The wheel assembly includes a plurality of wheel assemblies attached to the board, a first portion of the plurality of wheel assemblies being attached to the first portion of the board, and a second portion of the plurality of wheel assemblies being attached to the second portion of the board. The plurality of wheel assemblies include a bearing defining a bearing axis. The plurality of wheel assemblies further include a frame configured for mounting to the bearing to rotate about the bearing axis. The plurality of wheel assemblies further include an axle mounted to the frame. The plurality of wheel assemblies include at least one wheel mounted on the axle to rotate about a wheel axis. The frame is reconfigurable between a locked condition and an unlocked condition, wherein when in the locked condition the frame is fixed in relation to its rotation about the bearing axis and in the unlocked condition the frame is free to rotate about the bearing axis.

In another aspect, the frame further comprises a locking arrangement configured for locking the frame in one of its locked condition and its unlocked condition, the locking arrangement including a locking member.

In yet another aspect, the frame further comprises at least one receiving aperture about its periphery adapted to at least partially receive the locking member.

In another aspect, the locking member is movable between a locked position and an unlocked position, wherein in the locked position the locking member is engaged with the receiving aperture and in the unlocked position the locking member is disengaged with the receiving aperture.

In a further aspect, the locking member is adjustable externally to the housing by an adjusting member attached to the locking member.

Preferably, the locking member is biased towards the locked position by a resilient member.

In a further aspect the bearing is at least partially mounted to a housing.

Preferably, the housing is attached to the board by way of a support member attached between the board and the housing.

In a further aspect, the invention may be said to consist of a skateboard, comprising:
wheel assembly for a recreational vehicle, the wheel assembly comprising:
   a. a bearing defining a bearing axis, the bearing adapted to be mounted to a recreational vehicle body;
   b. a frame configured for mounting to the bearing to rotate about the bearing axis;
   c. an axle mounted to the frame;
   d. at least one wheel mounted on the axle to rotate about a wheel axis;
   e. wherein the frame is configurable between a locked condition and an unlocked condition, wherein when in the locked condition the frame is fixed in relation to its rotation about the bearing axis and in the unlocked condition the frame is free to rotate about the bearing axis.

In one aspect, the invention may be said to consist in a skateboard including a bearing defining a bearing axis, the bearing adapted to be mounted to a recreational vehicle body. The skateboard includes a frame configured for mounting to the bearing to rotate about the bearing axis. The skateboard further includes an axle mounted to the frame. The skateboard further includes at least one wheel mounted on the axle to rotate about a wheel axis. The skateboard further includes the frame which is configurable between a locked condition and an unlocked condition, wherein when in the locked condition the frame is fixed in relation to its rotation about the bearing axis and in the unlocked condition the frame is free to rotate about the bearing axis.

In a further aspect, the invention may be said to consist of a wheel assembly for a recreational vehicle, the wheel assembly comprising:
a. at least one wheel rotatable about a wheel axis to traverse a surface in use, the wheel being configured to be mountable to a recreational vehicle body to rotate about a rotating axis to allow the wheel to travel in a plurality of traverse directions; and
b. a locking arrangement configured to move between:
   i. an unlocked condition in which the wheel is rotatable about the rotating axis; and
   ii. a locked condition in which the wheel is rotatable about the wheel axis and locked to restrict rotation of the wheel about the rotating axis to move in a predetermined direction of travel relative to the recreational vehicle body.

In one aspect, the wheel assembly includes an axle on which the wheel is rotatably mounted to rotate about the wheel axis.

Preferably, the wheel assembly further includes a frame on which the axle is mounted.

In a further aspect, the wheel assembly includes a bearing, the bearing including a plurality of races, the races being rotatable relative to each other about the rotating axis.

In one aspect the invention may be said to consist of a bearing. The bearing includes a fixed race adapted to be fixedly mounted to the recreational vehicle body. The bearing further includes a rotating race coupled to the axle to rotate with the axle. The bearing includes two races comprising an inner race and an outer race rotatable relative to the inner race.

In a further aspect, the outer race of the bearing is configured to be mounted to the recreational vehicle body.

Preferably, the inner race of the bearing is mounted to the frame.

In one aspect, the frame includes a lip for supporting the bearing in use.

In a further aspect, the frame is lockable by way of the locking arrangement.

In another aspect, the locking arrangement includes locking pin.

Preferably, the locking pin is slidably movable.

In one aspect, the wheel assembly includes a truck.

In a further aspect, the locking pin is received into the truck.

Preferably, the locking arrangement is biased by a biasing arrangement to one of the locked condition and the unlocked condition.

In one aspect, the locking pin includes a manually manipulable handle.

In a further aspect, the locking pin is movable between retracted position corresponding the unlocked condition and extended position corresponding to the locked condition of the locking arrangement.

Preferably, the locking pin is biased to one of the retracted position and the extended position.

Preferably, the locking pin when in an extended position is receivable into a receiving formation in the frame to thereby lock rotating movement of the frame about the rotating axis.

Preferably, the receiving formation is one or more selected from an aperture and a recess.

In one aspect, the bearing is at least partially mounted to a housing.

In another aspect, the housing is attached to the truck by way of a support member attached between the truck and the housing.

In a further aspect, the wheel assembly comprises a further bearing having an inner race and an outer race, wherein the outer race of the further bearing is securely fitted into the central hole of the wheel and the axle is securely attached to the inner race of the further bearing.

Preferably, the wheel assembly further comprises a frame securely attached to the inner race of the bearing, wherein the first end and the second end of the axle are attached to the frame.

In one aspect, the wheel assembly further comprises a circlip to securely fix the frame to the inner race of the bearing.

Preferably, the frame further comprises a first mounting hole to hold the first end of the axle and a second mounting hole to hold the second end of the axle.

In one aspect, the axle further comprises a first stopper positioned between the first mounting hole and the wheel and a second stopper positioned between the second mounting hole and the wheel to keep the wheel away from the inner race of the bearing.

Preferably, the first stopper and the second stopper are slidably attached to the axle.

In another aspect, the wheel assembly further comprises a housing, and a locking plate that securely attaches to the housing and to the outer race of the bearing, such that the housing at least partially covers the wheel.

Preferably, the locking plate includes a groove that securely attaches the locking plate to the outer race of the bearing.

In one aspect, the housing includes a set of tabs that securely attaches the housing to the locking plate.

In yet another aspect, the locking plate includes a thread around a periphery of the locking plate to threadably attach the housing to the locking plate.

Preferably, the housing is hemi-spherical in shape.

In another aspect the invention may be said to consist in a skateboard, comprising:
a. a board having a first portion and a second portion; and
b. a plurality of wheel assemblies attached to the board, a first portion of the plurality of wheel assemblies being attached to the first portion of the board, and a second portion of the plurality of wheel assemblies being attached to the second portion of the board, wherein each of the plurality of wheel assemblies comprises:
c. a wheel having a central hole;
d. an axle having a first end and a second end, the axle extending through the central hole of the wheel to enable the wheel to rotate about the axle; and
e. a bearing having an inner race and an outer race, the first end and the second end of the axle being attached to the inner race of the bearing to enable the axle to rotate with the inner race of the bearing relative to the outer race of the bearing.

In one aspect, the first portion of the plurality of wheel assemblies include two wheel assemblies that are attached to the first portion of the board, and the second portion of wheel assemblies include two wheel assemblies that are attached to the second portion of the board.

In one aspect, each of the plurality of wheel assemblies may be said to consist of a further bearing having an inner race and an outer race, wherein the outer race of the further bearing is securely fitted into the central hole of the wheel and the axle is securely attached to the inner race of the further bearing.

In one aspect, each of the plurality of wheel assemblies further comprises a frame securely attached to the inner race of the bearing, wherein the first end and the second end of the axle are attached to the frame.

In a further aspect, each of the plurality of wheel assemblies further comprises a circlip to securely fix the frame to the inner race of the bearing.

Preferably, the frame comprises a first mounting hole to hold the first end of the axle and a second mounting hole to hold the second end of the axle.

In one aspect, the axle includes a first stopper positioned between the first mounting hole and the wheel and a second stopper positioned between the second mounting hole and the wheel to keep the wheel away from the inner race of the bearing.

In another aspect, the first stopper and the second stopper are slidably attached to the axle.

In a further aspect, the plurality of wheel assemblies further comprises a housing. The plurality of wheel assemblies includes a locking plate that securely attaches to the housing and to the outer race of the bearing, such that the housing at least partially covers the wheel.

In one aspect, the locking plate includes a groove that securely attaches the locking plate to the outer race of the bearing.

In yet another aspect, the housing includes a set of tabs that securely attaches the housing to the locking plate.

In one aspect, the locking plate includes a thread around a periphery of the locking plate to threadably attach the housing to the locking plate.

Preferably, the housing is hemi-spherical in shape.

In one aspect, the skateboard may be said to consist of a first skateboard truck attached between the first portion of the plurality of wheel assemblies and the first portion of the board. The skateboard includes a second skateboard truck attached between the second portion of the plurality of wheel assemblies and the second portion of the board.

In one aspect, the first skateboard truck is attached to the housing of each of the first portion of the plurality of wheel assemblies, and the second skateboard truck is attached to the housing of each of the second portion of the plurality of wheel assemblies.

In another aspect, the first skateboard truck is releasably attachable to the housing of each of the first portion of the plurality of wheel assemblies, and the second skateboard truck is releasably attachable to the housing of each of the second portion of the plurality of wheel assemblies.

In another aspect the invention may be said to consist in a wheel assembly comprising:
a. a bearing at least partially rotatable about a bearing axis;
b. a frame configured for mounting to the bearing to rotate about the bearing axis;
c. an axle mounted to the frame; and
d. at least one wheel mounted on the axle to rotate about a wheel axis;
wherein the frame includes a supporting lip on which the bearing is supportable in use.

In another aspect the invention may be said to consist in a skateboard, comprising:
a. a board including a first portion and a second portion; and
b. a plurality of wheel assemblies attached to the board, a first portion of the plurality of wheel assemblies being attached to the first portion of the board, and a second portion of the plurality of wheel assemblies being attached to the second portion of the board, wherein each of the plurality of wheel assemblies comprises:
   i. a bearing at least partially rotatable about a bearing axis;
   ii. a frame configured for mounting to the bearing to rotate about the bearing axis;
   iii. an axle mounted to the frame; and
   iv. at least one wheel mounted on the axle to rotate about a wheel axis;
      wherein the frame includes a supporting lip on which the bearing is supportable in use.

In another aspect, the bearing defines an internal aperture and the frame extends through the internal aperture.

In yet another aspect, the wheel assembly comprises a circlip to securely fix the frame to the bearing.

In one aspect, the wheel assembly comprises an axle further comprising a first end and a second end wherein, the first end and the second end of the axle are attached to the frame.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 is an exploded view of a wheel assembly in accordance with an embodiment of the present invention;

FIG. 2 is a further exploded view of the embodiment of FIG. 1 revealing a cut-out of a housing in accordance with the present invention;

FIG. 3 is a top perspective view of the wheel assembly of FIG. 1 attached to a skate board;

FIG. 4 is an underside perspective view of the embodiment shown in FIG. 3;

FIG. 5 is a side view of the embodiment shown in FIG. 3;

FIG. 6 is a side view of the embodiment shown in FIG. 3, revealing a cut-away of the wheel assembly;

FIG. 7 is a rear perspective of the embodiment of FIG. 3;

FIG. 8 is a further embodiment of the invention in which the wheel assemblies are attached to a roller skate;

FIG. 9 is a side view of the embodiment shown in FIG. 8;

FIG. 10 is a side view of the embodiment of FIG. 8 in use with a person's foot;

FIG. 11 is a side view of the embodiment shown in FIG. 8 revealing a cut-out of the wheel assemblies;

FIG. 12 is a rear view of the embodiment shown in FIG. 8;

FIG. 13 is an underside view of the embodiment of FIG. 8;

FIG. 14 is a top view of the embodiment shown in FIG. 8;

FIG. 15 is an exploded view of the wheel assembly in accordance with another embodiment of the present invention;

FIG. 16 is an exploded view revealing a cut-away of the housing of the embodiment of FIG. 15;

FIG. 17 shows the embodiment of FIG. 15 attached to a skateboard truck;

FIG. 17a shows a cut-away section of the wheel assembly of FIG. 15;

FIG. 17b shows a further cut-away of the wheel assembly of FIG. 15;

FIG. 18 shows a perspective view of the wheel assembly of FIG. 15 showing a locking member removed;

FIG. 19 shows a further cut-away perspective of the wheel assembly of FIG. 15 in its locked condition; and

FIG. 20 shows the embodiment of FIG. 19 in its unlocked condition.

### DETAILED DESCRIPTION

It should be noted in the following description that like or the same reference numerals in different embodiments denote the same or similar features.

A wheel assembly is described below with reference to its application on a skateboard including a board 302, however it will be appreciated that the wheel assembly 100 could be applied to other suitable recreational vehicles that include varying recreational vehicle bodies, such as scooters, trikes, roller skates or the like.

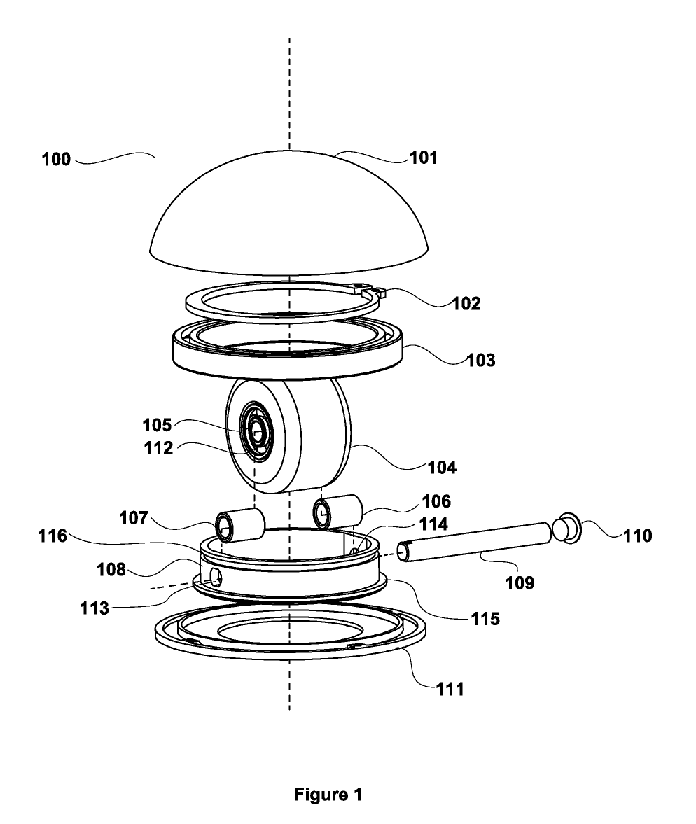

An exploded view of a wheel assembly 100 in accordance with the present invention is exemplified in FIG. 1. The wheel assembly 100 comprises a wheel 104 having a central hole 105, an axle 109 having a first end and a second end, the axle 109 being designed to extend through the central hole 105 of the wheel 104 to enable the wheel 104 to rotate about the axle 109. The wheel assembly 100 further comprises a bearing 103, which may be a ball bearing, rolling element bearing or a tapered rolling bearing among many other possible varieties of bearings. It will be appreciated by a person skilled in the art that tapered roller bearings and the like may be appropriate for the purposes of the present invention given the loadings on the bearing structure, due to the bearings horizontal orientation. The bearing 103 has a rotating race in the form of an inner race and a fixed race in the form of an outer race. The first end and the second end of the axle 109 are attached to the inner race of the bearing 103 to enable the axle 109 to rotate with the inner race of the bearing 103 relative to the outer race of the bearing 103. The outer race is coupled to the board via a truck 303 to be fixedly secured to the board 302 as will be described in more detail below. Once assembled, as the first end and the second end of the axle 109 are attached to the inner race of the bearing 103, such a compact structure of the wheel assembly 100 makes the centre of gravity of the wheel assembly 100 close to the axle 109 about which the wheel 104 rotates, which improves the general handling characteristics of the wheel assembly 100 and prolongs the lifetime of the wheel assembly 100. The details as to the attachment of the axle 109 to the inner race of the bearing 103 will be discussed further below. The bearing 103 is used to allow for 360 degree rotation of the wheel 104 and axle assembly 109 relative to the outer race of the bearing 103.

The wheel assembly 100 further comprises another bearing 112 having an inner race and an outer race, where the outer race of the bearing 112 is securely fitted into the central hole 105 of the wheel 104, by way of a slip fit or interference fit. The bearing 112 serves the purpose to reduce the friction of the rotational motion of the wheel 104 in relation to the axle 109. The axle 109 is securely attached to the inner race of the bearing 112, by way of a slip fit or an interference fit.

The wheel assembly 100 further comprises a frame 108 securely attached to the inner race of the bearing 103, by way of a slip fit or an interference fit. The frame 108 is used as a means of attaching the axle 109 to the inner race of the bearing 103. The frame 108 comprises a bottom lip 115 to aid in the positioning of the bearing 103 and furthermore comprises a groove 116 for fitment of a circlip 102, the purpose of which will be discussed further below. The outer diameter of the frame 108 is substantially equal to the inner diameter of the inner race of the bearing 103, providing for a snug fit. The first end and the second end of the axle 109 are attached to the frame 108, the details of which will be discussed below.

The wheel assembly 100 further comprises a circlip 102 used to securely fix the frame 108 to the inner race of the bearing 103. The circlip 102 is one of a number of possible methods which may be used to securely attach the frame 108 in fixed relation to the inner race of the bearing 103. Other more permanent methods of securely attaching the frame 108 to the bearing 103 may include an epoxy resin or another suitable adhesive. The circlip 102 was chosen to allow for easy removal and hence serviceability of the bearing 103.

The attachment of the axle 109 to the frame 108 is facilitated by the use of two mounting holes 113 and 114, that being a first mounting hole 114 to hold the first end of the axle 109 and a second mounting hole 113 to hold the second end of the axle 109. The axle 109 passes through the two mounting holes 113 and 114 securing the axle 109 to the frame 108.

The axle 109 further includes a first stopper 106 positioned between the first mounting hole 114 and the wheel 104 and a second stopper 107 positioned between the second mounting hole 113 and the wheel 104 to keep the wheel 104 away from the inner race of the bearing 103 by reducing and limiting the lateral movement of the wheel 104 along the axle 109. The first stopper 106 and the second stopper 107 are slidably attached to the axle 109 which allows for easy attachment and assembly. In this embodiment, the first stopper 106 and the second stopper 107 are in the form of a tube.

A cap 110 is inserted on one end of the axle 109, which in this embodiment is the first end of the axle 109, although it is noted that it could equally be used on the second end of the axle 109 to the same effect. The cap 110 is provided in order to prevent movement of the axle 109 within the frame 108, by providing for a tight fit of the axle 109 within the first mounting hole 114 of the frame 108 in this embodiment.

The wheel assembly 100 further comprises a housing 101, and a locking plate 111 that securely attaches to the housing 101 and to the outer race of the bearing 103, such that the housing 101 at least partially covers the wheel 104.

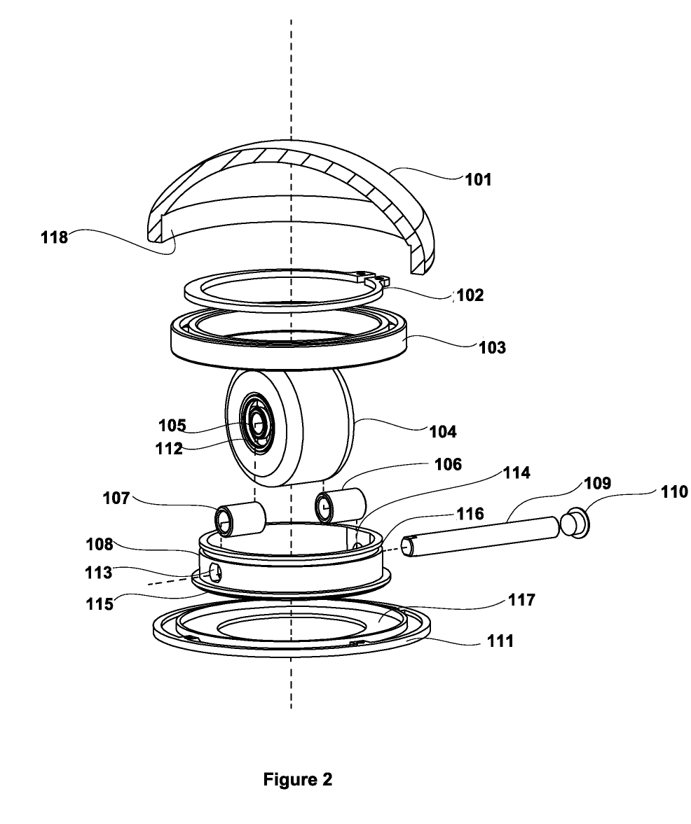

FIG. 2 shows the locking plate 111 which includes a groove 117 that securely attaches the locking plate 111 to the outer race of the bearing 103. The groove in the locking plate 111 also aids in the positioning of the bearing 103 in relation to the locking plate 111.

In FIG. 2 the internal structure of the housing 101 is revealed exemplifying how the outer race of the bearing 103 is slidably attached to the housing 101, by way of a recess 118 within the circumference of the housing 101 allowing for the outer race of the bearing 103 to be slidably attached to the housing 101, by way of an interference fit.

In FIG. 2 the housing 101 includes a set of tabs (not shown) that securely attaches the housing 101 to the locking plate 111. Other methods of attaching the housing 101 to the locking plate 111 may include the use of screws or a suitable adhesive such as an epoxy resin. In this embodiment the method of attachment using tabs (not shown) allows for easy removal of the locking plate 111 when servicing the wheel assembly 100.

In another embodiment, the locking plate 111 includes a thread (not shown) around a periphery of the locking plate 111 to threadably attach the housing 101 to the locking plate 111. In this embodiment the thread (not shown) has been chosen to allow for servicing of the wheel assembly 100, and would only require a suitable tool for removal of the locking plate 111 by a service technician.

The housing 101 may be any shape, with the example presented in the figures being hemi-spherical, however the housing 101 is not limited to a hemi-spherical shape and could be square or any other appropriate shape depending on the application. The hemi-spherical shaped housing 101 provides for an aesthetically pleasing design and more importantly provides for a housing surface free of sharp edges in regards to general safety.

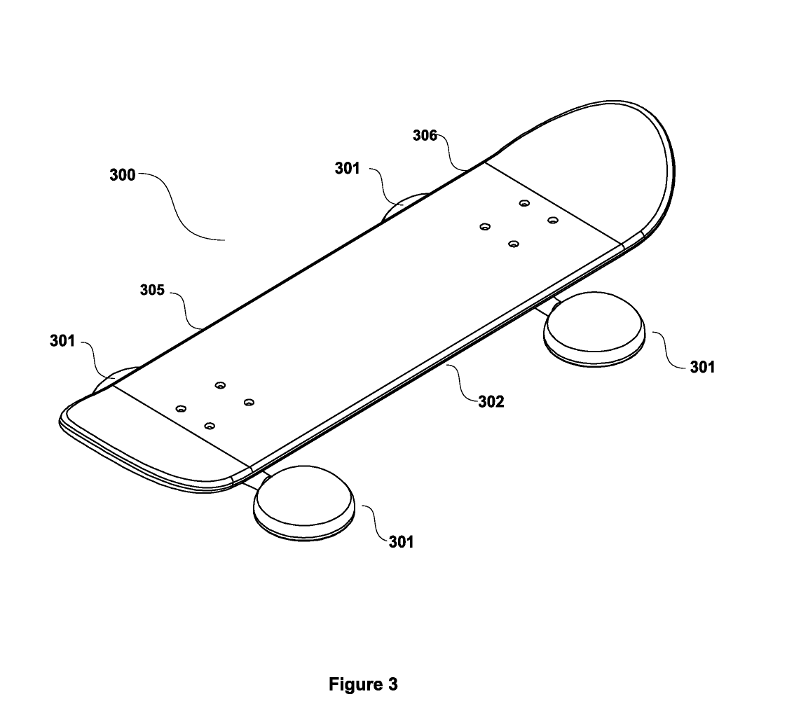

FIGS. 3-7 exemplify the use of the wheel assembly 100 to the application of a skateboard 300 and will be described in further detail below.

FIG. 3 demonstrates the application of the wheel assembly 100 to a skateboard 300, comprising a board 302 having a first portion 305 and a second portion 306 and a plurality of wheel assemblies 301 attached to the board 302, a first portion of the plurality of wheel assemblies 301 being attached to the first portion 305 of the board 302, and a second portion of the plurality of wheel assemblies 301 being attached to the second portion 306 of the board 302. As described with reference to FIGS. 1 and 2, each of the wheel assemblies 301 comprises the wheel 104 having the central hole 105, the axle 109 having a first end and a second end, the axle 109 being designed to extend through the central hole 105 of the wheel 104 to enable the wheel to rotate about the axle 109. The wheel assembly 301 further comprises the bearing 103. The bearing 103 has an inner race and an outer race. The first end and the second end of the axle 109 are attached to the inner race of the bearing 103 to enable the axle 109 to rotate with the inner race of the bearing 103 relative to the outer race of the bearing. Since the gravity centre of the wheel assembly 301 is close to the axle 109, as described above with reference to FIG. 1, the application of the wheel assembly 301 to the skateboard 300 as shown in FIGS. 3 to 7 lowers the gravity centre of the skateboard 300 when the skateboard 300 is placed on the ground, which leads to better handling characteristics of the skateboard 300.

In the embodiment exemplified in FIG. 3, the first portion of the plurality of wheel assemblies include two wheel assemblies 301 that are attached to the first portion 305 of the board 302, and the second portion of wheel assemblies include two wheel assemblies 301 that are attached to the second portion 306 of the board 302.

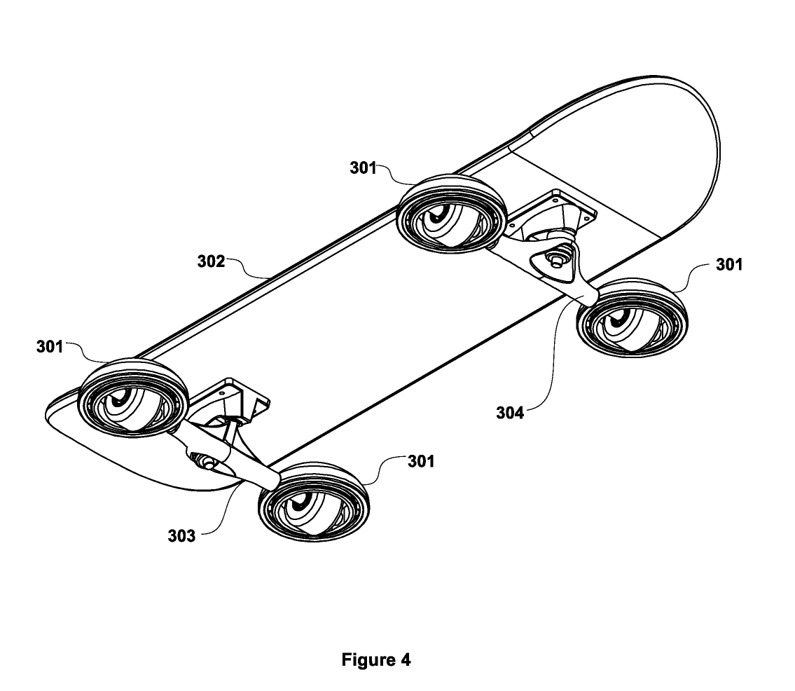

In FIG. 4 the skateboard 300 further comprises a first skateboard truck 303 attached between the first portion 305 of the board 302 and the plurality of wheel assemblies 301, which in this embodiment is two wheel assemblies 301. The skateboard 300 further comprises a second skateboard truck 304 attached between the second portion 306 of the board 302 and the plurality of wheel assemblies 301, which in this embodiment is two wheel assemblies 301. The skateboard trucks 303 and 304 may be attached to the board 302 using screws, although bolts would also be a suitable attachment method allowing for the removal of the skateboard trucks 303 and 304 from the board 302 while being serviced.

In FIG. 4 the skateboard trucks 303 and 304 could be of the off the shelf variety, or may be custom made depending on the application. The wheel assemblies 301 in one embodiment are attached to the side of the trucks 303 and 304 by way of a weld for example, they could also be attached using one or more bolts or another removable attachment means (not shown).

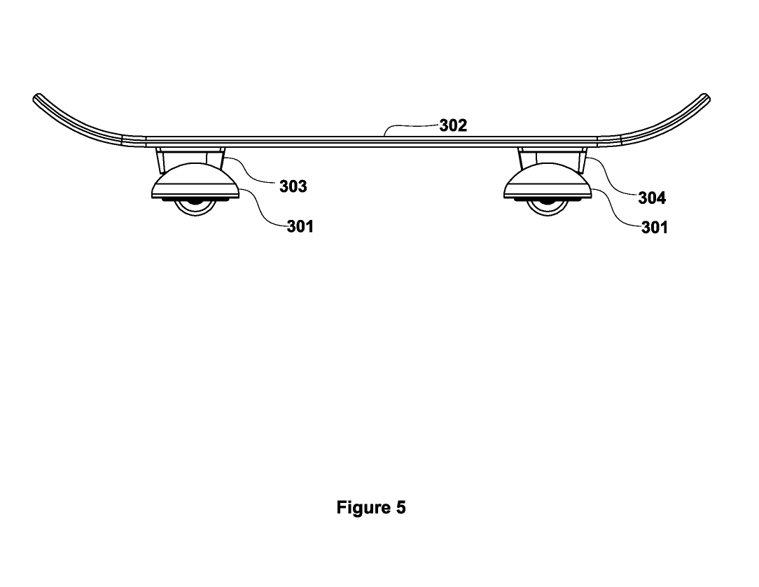

FIG. 5 shows a side view of the skateboard 300 showing the attachment of the wheel assemblies 301 to the board 302 with the use of the truck assemblies 303 and 304.

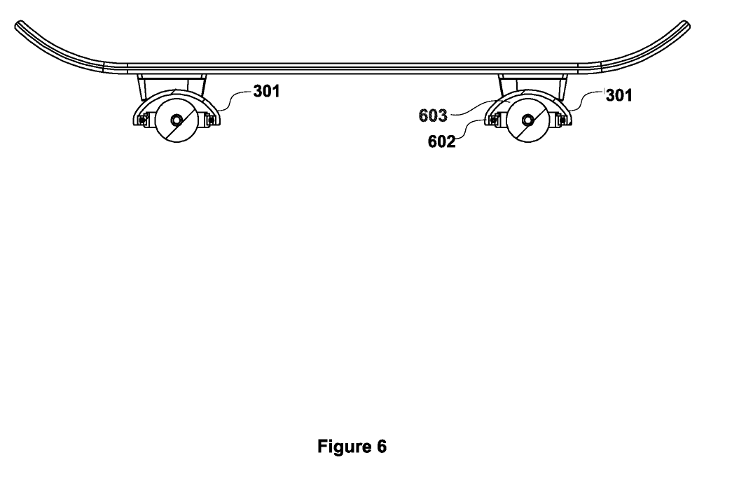

In FIG. 6 the internal structure of the wheel assemblies 301 is shown by way of a cutaway section revealing the clearance of the wheel 603 in relation to the top of the housing 602. The clearance has been kept to a minimum to further lower the centre of gravity of the skateboard 300, which will aid in the handling of the skateboard 300 improving the user experience.

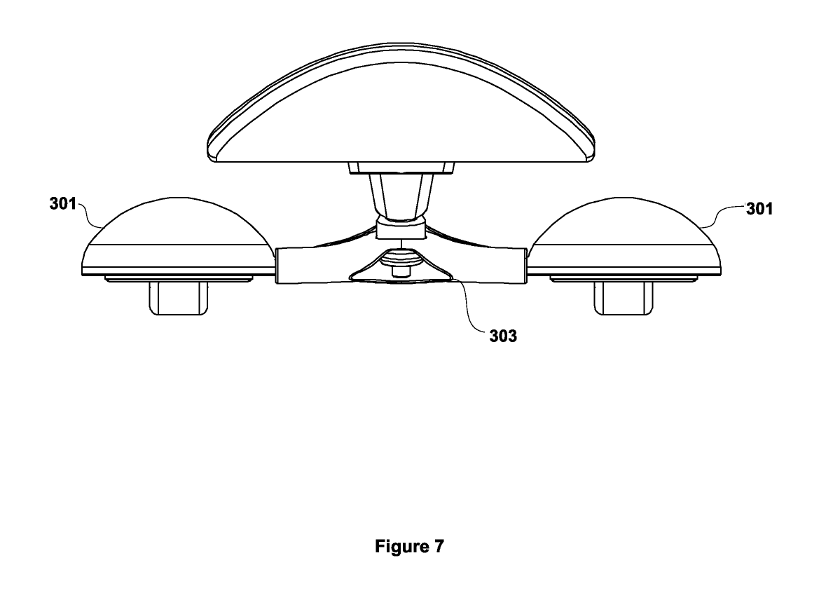

The configuration as exemplified in FIG. 7 is once again chosen to allow the board 300 to sit as low as possible resulting in a low centre of gravity for the skateboard 300, which as mentioned previously will have a positive effect on the control and handling of the skateboard 300. FIG. 7 aids to show the positioning of the wheel assemblies 301 in relation to the skateboard truck 303.

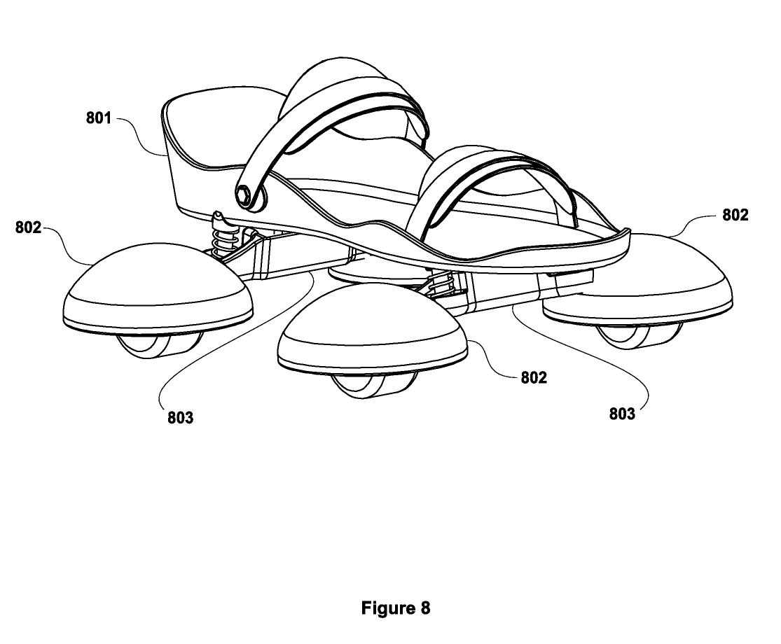

A further example involves the application of the wheel assemblies 802 to a set of roller skates as exemplified in FIG. 8. In FIG. 8 the roller skate platform 801 is attached to the wheel assemblies 802 using truck assemblies 803 similarly to the skateboard implementation of FIGS. 3-7. As with the skateboard 300, the roller skates make use of a conventional truck assembly 803 and the attachment of the wheel assemblies 802 may be achieved in a similar fashion to that of the skateboard 300, where the wheel assemblies 802 may be attached to the truck assemblies 803 by a weld attachment or a semi-permanent releasable attachment such as one or more attachment bolts.

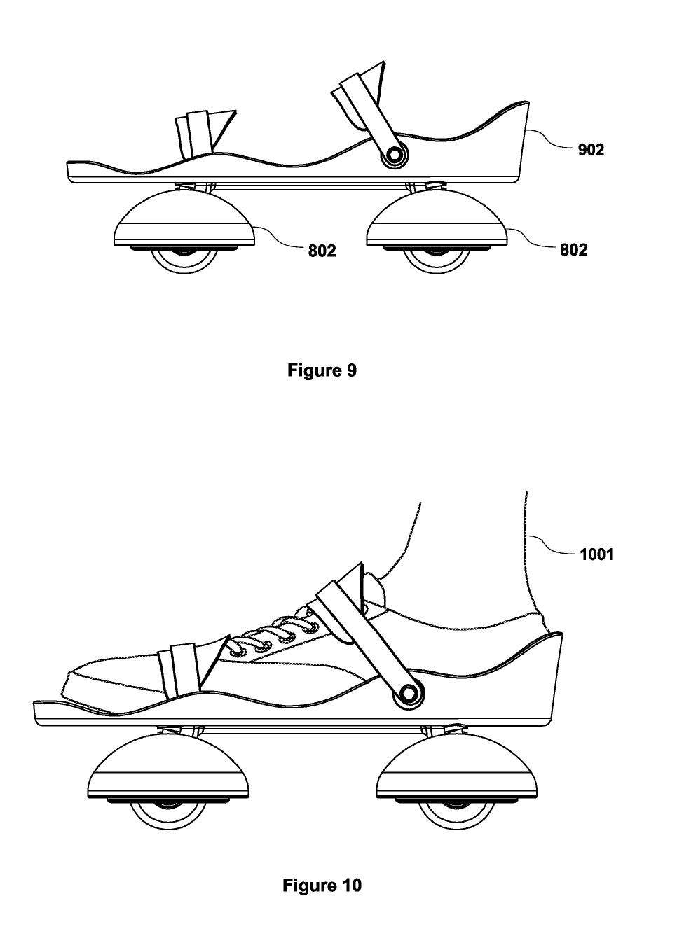

FIG. 9 shows a side view of the roller skate implementation of the invention showing the relation between the wheel assemblies 802 and the roller skate platform 902.

FIG. 10 shows an example application showing the positioning of a person's foot 1001 in the roller skate.

FIG. 11 shows a side view of the roller skates revealing a cross sectional view of the wheel assemblies 802 and their attachment to the roller skate platform 902.

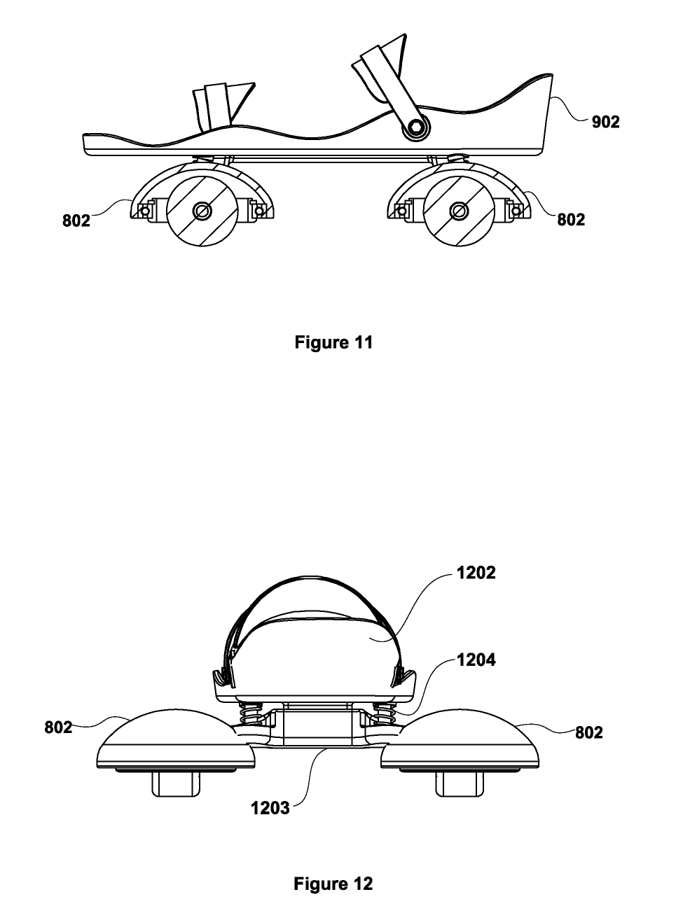

FIG. 12 shows a rear view of the roller skate implementation exemplifying the attachment of the wheel assemblies 802 to the roller skate platform 1202 through the use of the truck assembly 1203. FIG. 12 shows further detail of the truck 1203 and the suspension assembly 1204.

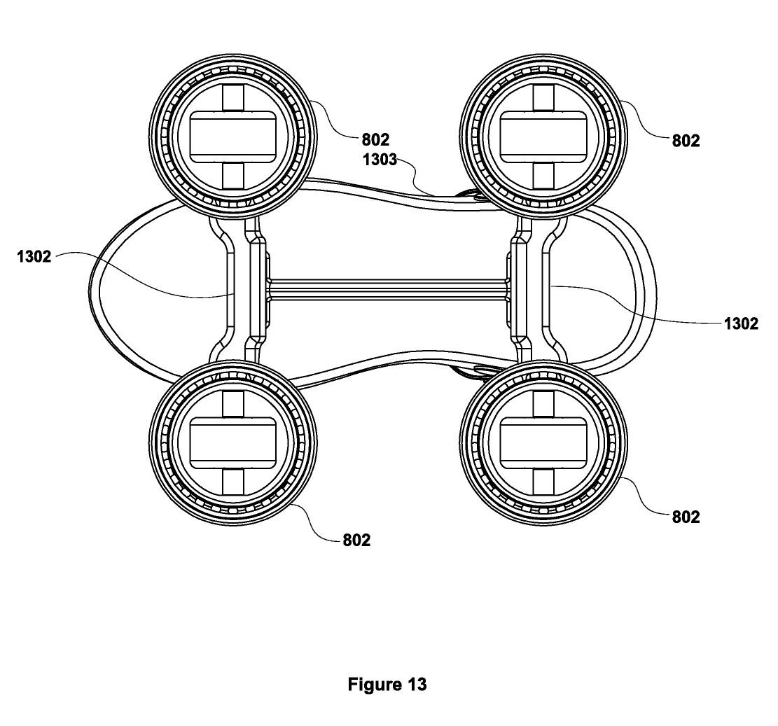

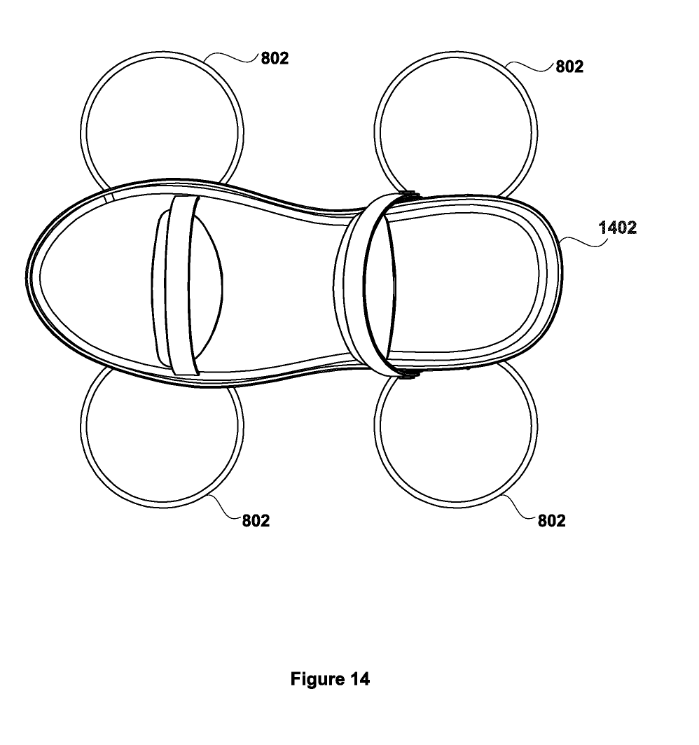

FIG. 13 provides an underside view of the roller skate assembly showing the attachment of the wheel assemblies 802 to the truck assemblies 1302, and the attachment of the truck assemblies 1302 to the roller skate platform 1303.

FIG. 14 provides a top view of the roller skate and the positioning of the wheel assemblies 802 in relation to the roller skate platform 1402.

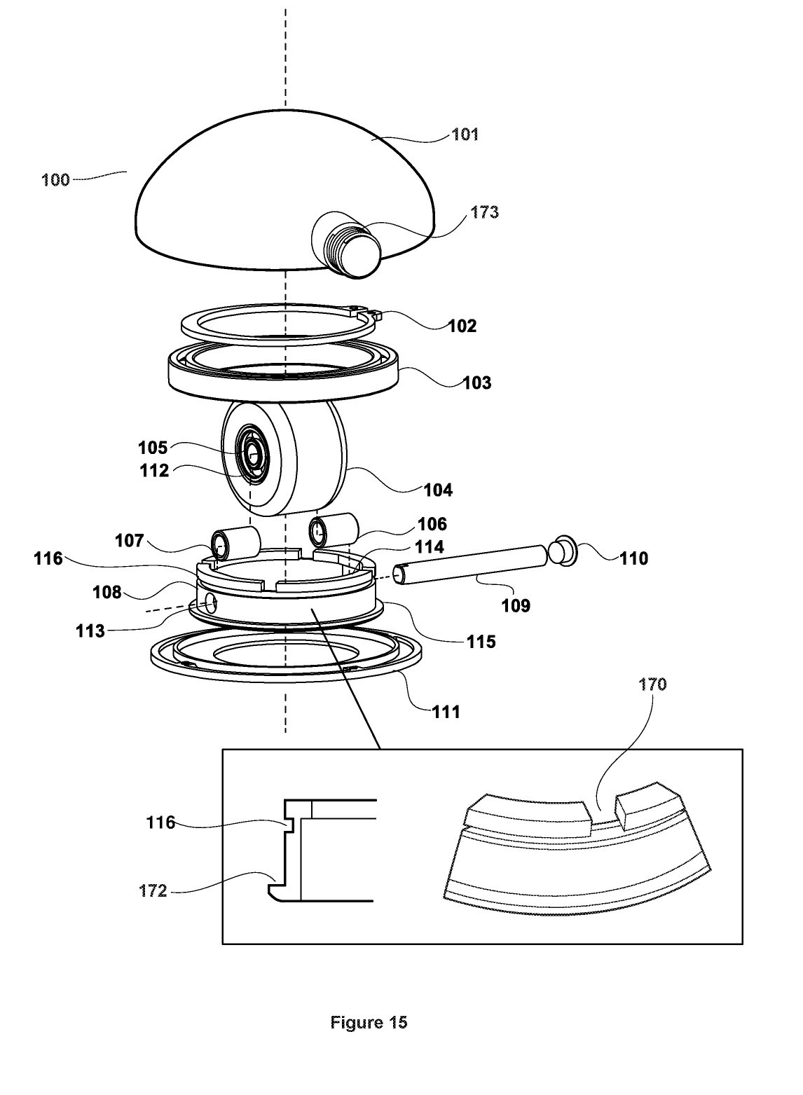

FIG. 15 shows a further embodiment of the present invention in which an attachment means 173, which is adapted to attach the housing 101 to a body of a recreational vehicle (not shown) enables the wheel assembly 100 to be attached to the recreational vehicle. In this embodiment the attachment means comprises a threaded member is attached to the housing 101 as an integral component of the housing 101. The attachment means 173 may be detachable to the housing 101 in a number of different ways as will be discussed below. The attachment means 173 may be used to attach the housing 101 to an object in use such as a roller skate platform 1202 or a skate board truck 303 as two examples.

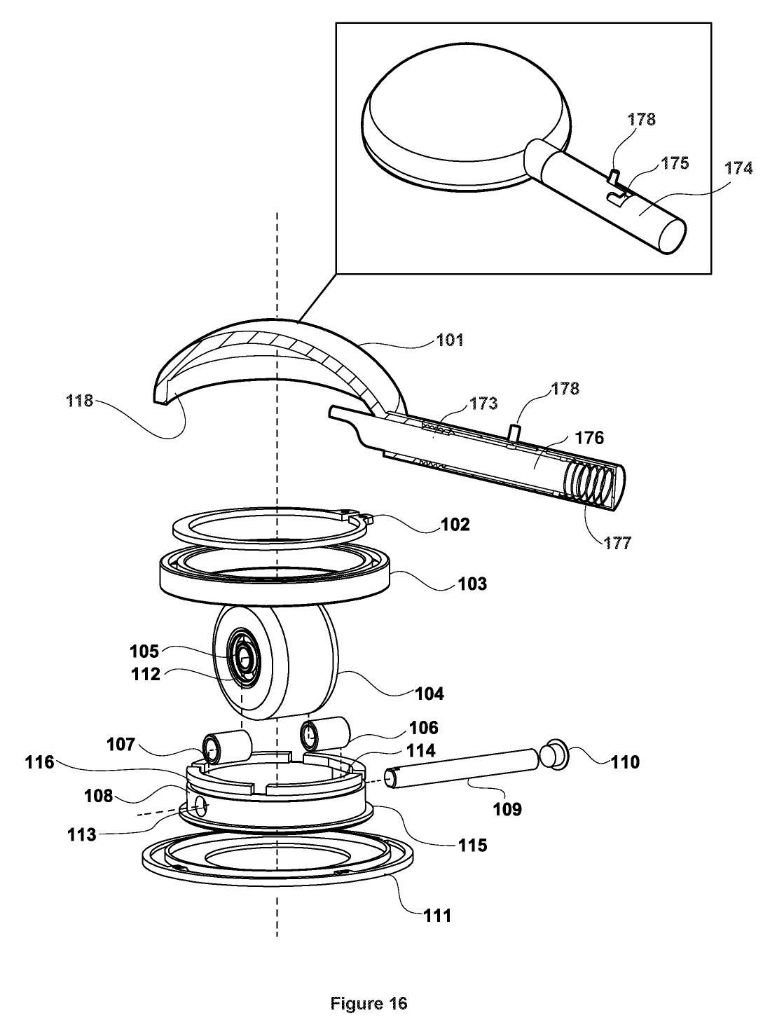

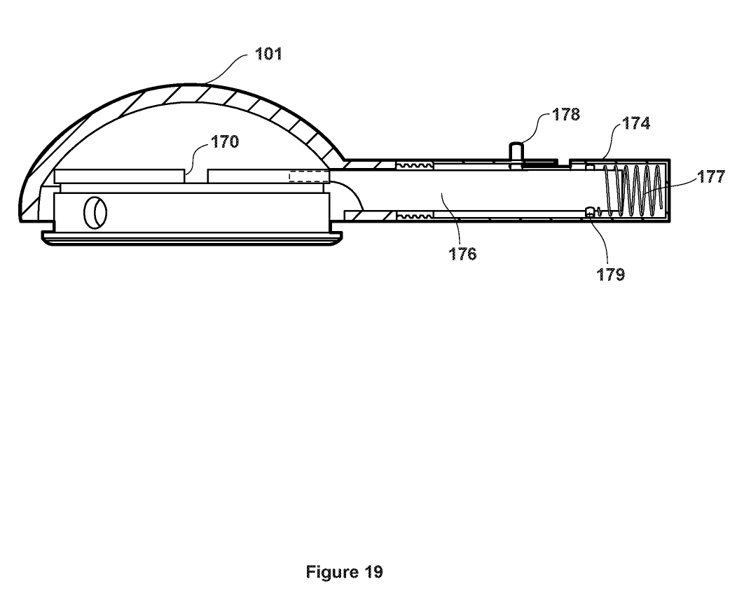

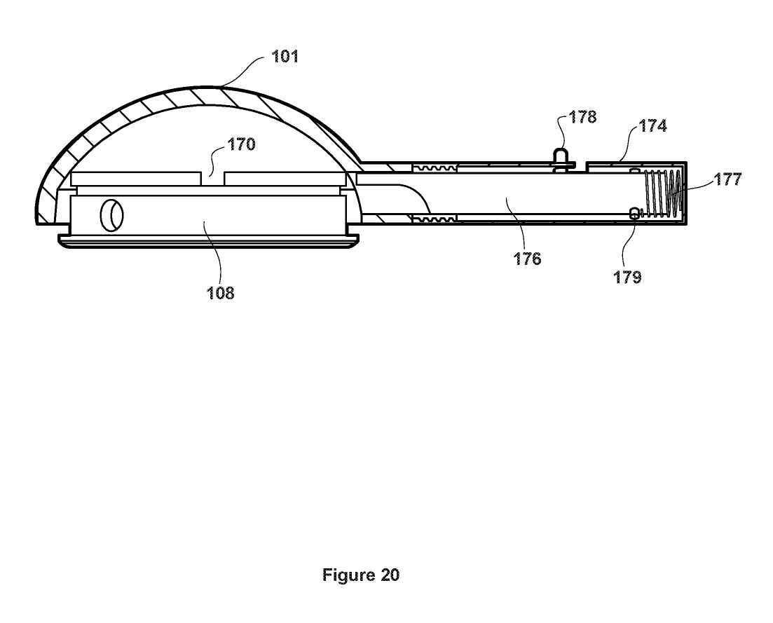

Alternatives to the attachment means 173, in the present embodiment may include but are not limited to a press fit or interference fit or alternatively a lockable bayonet attachment which may aid in the removal of the housing 101 to the attachment means 173. In the detail of FIG. 15 a further embodiment of the invention is shown detailing a mechanism for locking the rotation of the frame 108, allowing one to fix the movement of the frame 108 or alternatively to allow for 360 degree rotation of the frame 108. In the embodiment shown in FIG. 15, the frame 108 has at least one receiving aperture 170 adapted to receive at least one locking member 176 (shown in FIGS. 16-20). The locking member 176 is movable between a locked position and an unlocked position. In FIG. 19 the locking member 176 is shown in its locked position where the locking member is engaged with one of the receiving apertures 170 in the frame 108. FIG. 20 shows the frame in its unlocked position where the locking member 176 is disengaged with the receiving aperture 170 allowing the frame 108 to freely rotate about its axis.

The movement of the locking member 176 from its locked position to its unlocked position is achieved by way of an adjusting member 178 which protrudes through the support member 174 by way of an aperture configured to hold the adjusting member 178 in either the locked positon or the unlocked position. The locking member 176 is biased towards the locked position by a biasing arrangement or bias. In the embodiments shown the bias is a resilient member which in this embodiment is a spring 177. In order to move from the locked position to the unlocked position a user may manipulate the adjusting member 178 by their hand or a suitable adjustment tool as two examples, applying backward pressure away from the housing 101 to unlock the frame 108 and to lock the frame 108 the user would disengage the adjusting member 178 from its unlocked position and allow the spring 177 to return the adjusting member 178 into its locked position. A user would likely need to rotate the fame 108 such that the locking member 176 engages with one of the receiving apertures 170 around the perimeter of the frame 108.

As previously discussed, the movement of the locking member 176 is achieved by the manipulation of an adjusting member 178 within a receiving structure 175 adapted to locate the locking member 176 between its locked and unlocked state. The locking member further comprises a spring retainer 179 adapted to securely retain a resilient member which in this embodiment is a spring 177. The spring 177 being one of a number means of biasing the locking member in either of its locked or unlocked positions. Other means may include the use of a resilient member or an elastic biasing member.

FIG. 16 exemplifies the locking mechanism which comprises a locking member 176 which is activated by an adjustment member 178 which protrudes through an aperture 175 which is located on the attachment means 173. The locking member 176 is movable between a lock position and an unlocked position. The movability of the locking member 176 being achieved by movement of the adjustment member 178, designed to be adjusted by a person's hand or potentially by a tool as examples.

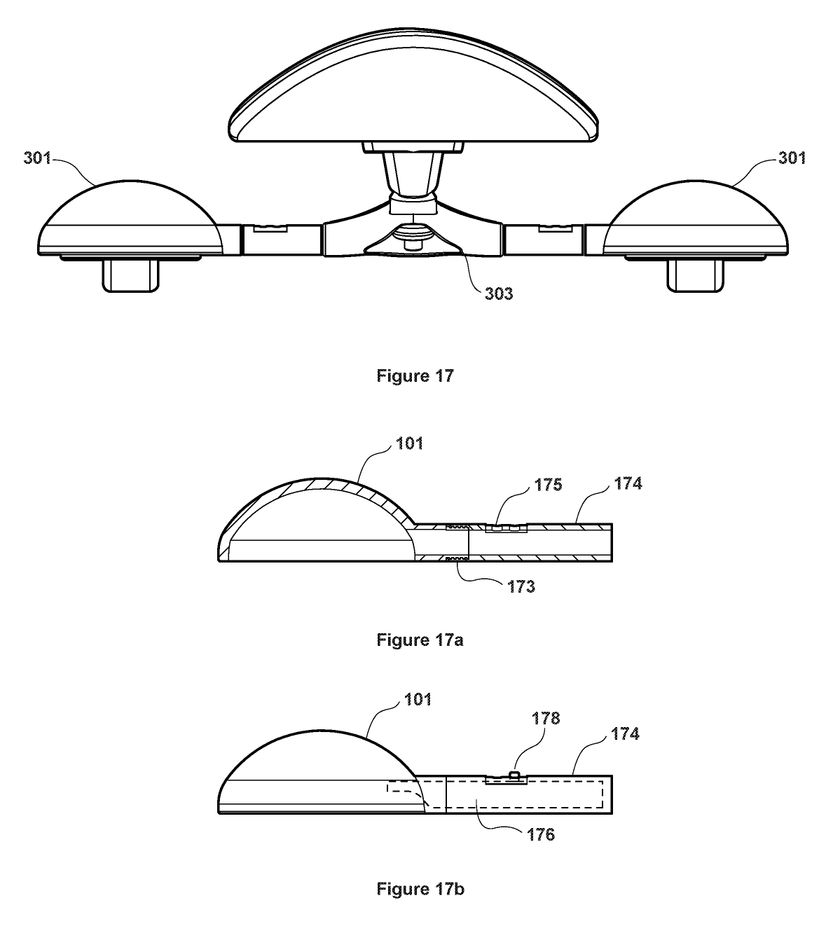

FIG. 17 exemplifies the attachment of the wheel assemblies 301 via an attachment means in the form of a support member 174 to the skateboard truck 303. In this embodiment, the support member 174 is threadably attached 173 to the housing 101. Other means of attaching the housing 101 to the support member may include a interference fit or press fit, allowing for the removal of the housing 101 for maintenance and assembly. A locking means for securing the housing 101 to the support member 174 will be described below.

FIGS. 17a and 17b show a side view of the housing 101 and the attachment means 173. As can be seen in FIG. 17b, the locking member 176 is housed within the support member 174 and is movable by way of the adjustment member 178.

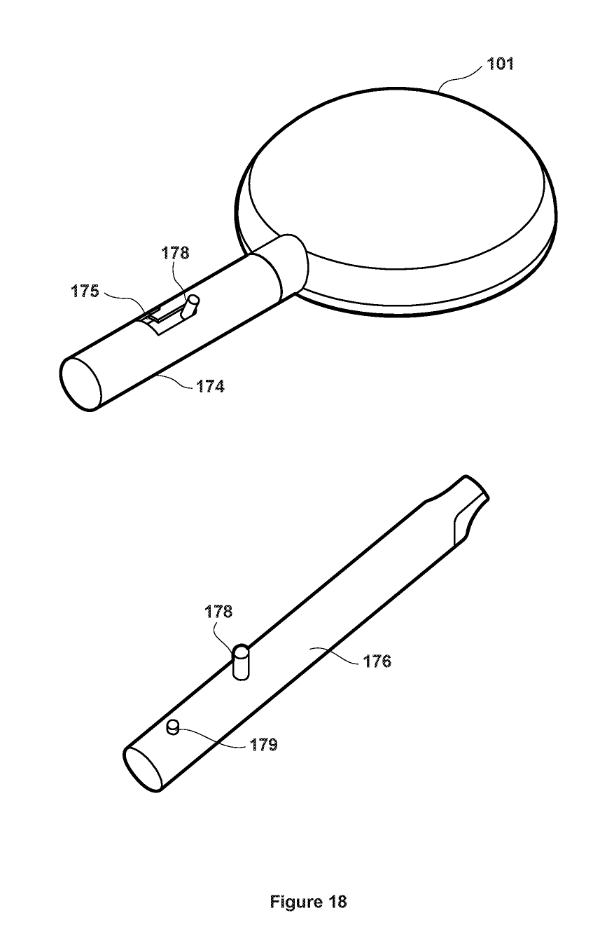

FIG. 18 shows the locking member 176 removed from the support member 174 showing the location of the adjustment member 178 and the spring retainer 179 in relation to the locking member 176.

FIG. 19 exemplifies the locking member 176 in its locked position when it is engaged with a receiving aperture 170. As discussed previously, the spring is biased to keep the locking member 176 in its locked position allowing the skateboard to which it is attached to be used in a standard skateboard configuration. However, if the user desires the locking member 176 may be moved into the unlocked position as is exemplified in FIG. 20, in the unlocked configuration the wheels of each wheel assembly 301 are each free to rotate about 360 degrees about their axis which is useful in a skate bowl for instance where the skateboard requires less control due to the structure of the skate bowl.

FIG. 20 shows the locking member 176 in its unlocked position where it is disengaged from the receiving aperture 170, this is achieved by applying pressure on the adjustment member 178 in the direction facing away from the housing 101 in which pressure is applied to the locking member 176 through the adjustment member 178. When in its unlocked position, the frame 108 is free to rotate 360 degrees about its axis. In the unlocked configuration the skateboard has free movement.

In use, the wheel assembly has a variety of different applications related to various uses such as a skateboard or roller skates as was described previously.

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the recreation and mechanical engineering industries.

1. A wheel assembly for a recreational vehicle, the wheel assembly comprising:
a) at least one wheel rotatable about a wheel axis to traverse a surface in use, the wheel being configured to be mountable to a recreational vehicle body to rotate about a rotating axis to allow the wheel to travel in a plurality of traverse directions; and
b) a locking arrangement configured to move between:
i) an unlocked condition in which the wheel is rotatable about the rotating axis; and
ii) a locked condition in which the wheel is rotatable about the wheel axis and locked to restrict rotation of the wheel about the rotating axis to move in a predetermined direction of travel relative to the recreational vehicle body.

2. The wheel assembly of claim 1, wherein the wheel assembly includes an axle on which the wheel is rotatably mounted to rotate about the wheel axis.

3. The wheel assembly of claim 2, wherein the wheel assembly further includes a frame on which the axle is mounted.

4. The wheel assembly of claim 3, wherein the wheel assembly includes a bearing, the bearing including a plurality of races, the races being rotatable relative to each other about the rotating axis.

5. The wheel assembly of claim 4, wherein the bearing includes:
a) a fixed race adapted to be fixedly mounted relative to the recreational vehicle body; and
b) a rotating race coupled to the axle to rotate with the axle.

6. The wheel assembly of claim 4, wherein the frame includes a lip for supporting the bearing in use.

7. The wheel assembly of claim 3, wherein the frame is lockable by way of the locking arrangement.

8. The wheel assembly of claim 1, wherein the locking arrangement includes locking pin.

9. The wheel assembly of claim 8, wherein the locking pin is slidably movable.

10. The wheel assembly of claim 1, wherein the wheel assembly includes a truck.

11. The wheel assembly of claim 10, wherein the locking pin is received into the truck.

12. The wheel assembly of claim 8, wherein the locking arrangement is biased by a biasing arrangement to one of the locked condition and the unlocked condition.

13. The wheel assembly of claim 8, wherein the locking pin includes a manually manipulable handle.

14. The wheel assembly of claim 13, wherein the locking pin is movable between retracted position corresponding the unlocked condition and extended position corresponding to the locked condition of the locking arrangement.

15. The wheel assembly of claim 14, wherein the locking pin is biased to one of the retracted position and the extended position.

16. The wheel assembly of claim 15, wherein the locking pin when in an extended position is receivable into a receiving formation in the frame to thereby lock rotating movement of the frame about the rotating axis.

17. The wheel assembly of claim 16, wherein the receiving formation is one or more selected from an aperture and a recess.

18. The wheel assembly of claim 17, wherein the bearing is at least partially mounted to a housing.

19. The wheel assembly of claim 18, wherein the housing is attached to the truck by way of a support member attached between the truck and the housing.

20. The wheel assembly of claim 1, wherein the recreational vehicle is a skateboard.
